(19) United States
(12) Patent Application Publication
(10) Pub. No.: US 2009/0213013 A1
(43) Pub. Date: Aug. 27, 2009

(54) ANTENNA FEEDING ARRANGEMENT

(76) Inventors: Bjorn Lindmark, Sollentuna (SE); Annika Hu, Akersherga (SE); Jesper Uddin, Stockholm (SE)

Correspondence Address: Myers Andras Sherman LLP, 19900 MacArthur Blvd., Suite 1150, Irvine, CA, 92612, US

(21) Appl. No.: 12/392,007

(22) Filed: Feb. 24, 2009

Related U.S. Application Data
(60) Provisional application No. 61/031,325, filed on Feb. 25, 2008.

(51) Int. Cl. H01Q 9/04

(52) U.S. Cl. 343/700 MS

(57) ABSTRACT

There is disclosed an antenna element, including at least one antenna patch and a feeding arrangement which comprises: a ground plane including: a first aperture slot and a second aperture slot, where said aperture slots cross each other perpendicularly; a feeding plane including: a first antenna port for feeding microwave energy via a first feeding junction into a first pair of feed lines which extend in parallel along said first aperture slot, on each side thereof; a second antenna port for feeding microwave energy via a second feeding junction into a second pair of feed lines which extend in parallel along said second aperture slot, on each side thereof; and where said feed lines cross each other in at least one point, at a mutual distance. Said feeding arrangement is furthermore irregularly configured for compensating for an imbalance caused by said crossing of said feed lines.

### RELATED APPLICATION INFORMATION

This application claims the benefit under 35 U.S.C. §119(e) of U.S. Provisional Patent Application Ser. No. 61/031,325, filed Feb. 25, 2008.

### TECHNICAL FIELDS

The present invention relates to a patch antenna element, and specifically to a dual polarized aperture coupled patch antenna element for the microwave range.

### BACKGROUND OF THE INVENTION

Dual polarized or X-polarized antennas are commonly used today in base stations for mobile communication systems. With such antennas polarization diversity techniques to combat signal fading in a radio transmission channel is made possible. Compared to systems employing vertical polarized antennas combined with space diversity techniques the number of antennas needed is reduced to half which saves cost and reduces the visual appearance of the antenna installation.

One important performance measure for dual polarized antennas is the isolation between the two antenna ports which feed the two polarizations. Typically, more than 30 dB isolation between the ports is specified which corresponds to a power coupling of less than 1/1000 between said antenna ports.

An aperture coupled patch antenna is a commonly employed antenna type for dual polarized systems. One or more metallic patches are fed by a micro strip feeding arrangement through a cross shaped aperture in a ground plane. Because of the symmetrical shape of the feeding arrangement the feed lines need to cross each other in at least one point. This crossing is typically achieved by using a so called air-bridge on one of the polarizations e.g. as shown in document U.S. Pat. No. 4,903,033 (Tsao et al).

A problem with the above prior art solution is the fact that a design with an air-bridge destroys the feeding symmetry and imposes an unwanted coupling between the two antenna ports which reduces the performance of the antenna.

A solution to the problem with unwanted coupling due to an air-bridge is proposed by Yamazaki (Electronic Letters, Vol. 30, No. 22, pp 1814-1815, 1994) in which two different dielectric boards with associated feed networks are separated by a ground plane layer. The drawback with this solution is a serious complication of the design process and the manufacture, and also increased costs because of the two separate dielectric boards.

Another solution to the above stated problem is disclosed in document WO 98/33234 A1 (Lindmark) where the problem is solved by an arrangement in which there is no air-bridge in the feeding arrangement, i.e. a design without any crossing of the feed lines. However, this solution suffers from an unbalanced excitation of the aperture slots which reduces the performance of the antenna system, also different length slots leads to different patch sizes and different radiation pattern in the principal E- and H-planes for the two polarization channels.

Therefore, there is a need in the art for a dual polarized patch antenna element having, in spite of one or more crossings, an improved isolation between the antenna ports compared to the prior art solutions above.

### SUMMARY OF THE INVENTION

The object of the present invention is to solve the aforementioned prior art problem of unwanted coupling between the antenna ports due to one or more crossings of the feed lines.

The problem is solved by a dual polarized aperture coupled patch antenna element as defined in claim 1.

An advantage with the present invention is that the coupling between the antenna ports imposed by one or more crossings is reduced while the radiation pattern remains symmetric. Another advantage with the present invention is that a high degree of freedom is possible when designing antennas of the present type.

### BRIEF DESCRIPTION OF THE DRAWINGS

The present invention will be explained with reference to the appended drawings in which:

FIG. 1A shows a feeding arrangement according to prior art with one crossing;

FIG. 1B shows an alternative feeding arrangement according to prior art with four crossings;

FIG. 2 shows a first embodiment of the present invention where at least one feeding junctions is displaced;

FIG. 3 shows a second embodiment of the present invention where at least one pair of feed lines is displaced;

FIG. 4 shows a third embodiment of the present invention where at least one aperture slot is displaced;

FIG. 5A shows a diagram of measured S-parameters for a feeding arrangement according to prior art;

FIG. 5B shows a diagram of measured S-parameters for a feeding arrangement according to one of the embodiments of the present invention where an irregular configuration is employed; and

FIG. 6 shows the radiation pattern of an antenna with a feeding arrangement according to one of the embodiments of the present invention.

### DETAILED DESCRIPTION OF THE INVENTION

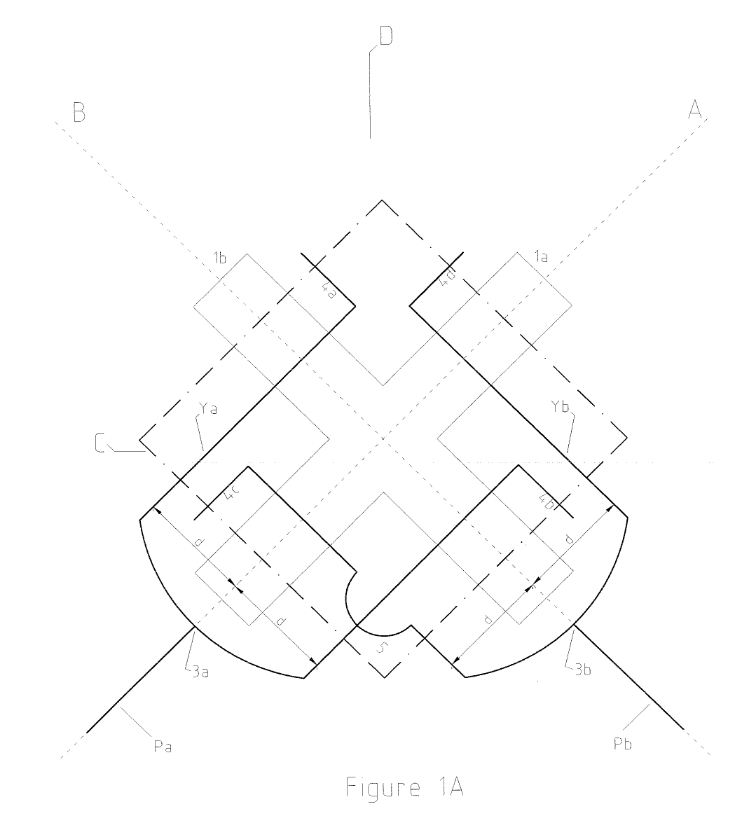

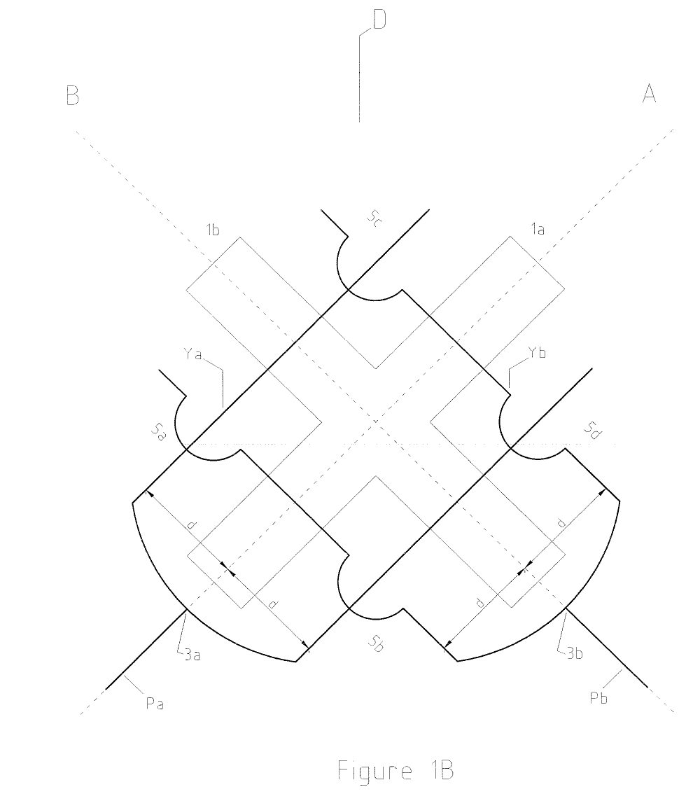

FIG. 1A shows a feeding arrangement according to prior art with a regular configuration. One or more metallic patches C are fed by a cross shaped aperture in the ground plane.

A feeding arrangement D shown in FIG. 1A comprises a ground plane with a first aperture slot 1a and a second aperture slot 1b where the slots cross each other perpendicularly to form a cross shaped aperture in the ground plane. Furthermore, the aperture slots in FIG. 1A cross each other perpendicularly and centrally so as to form a symmetric configuration.

The feeding arrangement further comprises a feeding plane with a first antenna port Pa for feeding microwave energy via a first feeding junction 3a into a first pair of feed lines Ya which extend in parallel along the first aperture slot 1a on each side of thereof, and a second antenna port Pb for feeding microwave energy via a second feeding junction 3b into a second pair of feed lines Yb which extend in parallel along the second aperture slot 1b on each side thereof.

The feeding junctions 3a and 3b are arranged on a centre line, A and B, of their associated pair of feed lines, and hence are symmetrically arranged in respect to said associated pair of feed lines.

Furthermore, the pair of feed lines Ya and Yb extend in parallel and equidistant (with a distance d) along their respective aperture slots 1a and 1b, and on each side thereof, respectively. Moreover, each pair of feed lines, Ya and Yb, incorporates two stubs, 4a-4b and 4c-4d, of equal length.

The feed lines cross each other in one point 5 at a mutual distance from each other to avoid direct conductive connection between the feed lines. A common solution, as previously mentioned, is to use air as a dielectric between the feed lines and therefore an air-bridge is often employed, but a person skilled in the art realizes that the present invention is also applicable to solutions with other dielectric material in the crossing.

In FIG. 1B an alternative regular configured feeding arrangement according to prior art is shown. The main difference between the feeding arrangements in FIGS. 1A and 1B is the number of crossings, there being four crossings 5a-5d in FIG. 1B. When designing dual polarized antennas a key issue in reducing cost is the replacement of Printed Circuit Boards (PCB) with sheet metal parts. Due to the design with sheet metal parts more than one crossing may be necessary as larger line width and larger feed network is required when replacing PCB with sheet metal. Another difference between the arrangements in FIGS. 1A and 1B is that no stubs are present in the arrangement in FIG. 1B. Obviously, stubs may be added to the feed lines in the arrangement in FIG. 1B.

Because of the symmetrical shape of the prior art feeding arrangement, the polarizations need to cross each other in at least one point. This problem is often resolved with an air-bridge which means that the two polarizations cross each other at a mutual distance. The drawback with this regular configured design is that the symmetrical feeding is destroyed by the crossing which will result in an unwanted coupling between the two antenna ports.

The present invention solves the aforementioned problem with a novel design of the feeding arrangement in which the regular configuration of the feeding arrangement according to prior art is replaced by an irregular configuration of the feeding arrangement, and thereby compensating for the imbalance caused by one or more crossings.

It has been realized that the isolation between the antenna ports is improved if the feeding arrangement is irregularly configured compared to the prior art solutions. The irregular configuration will result in an additional asymmetrical feeding which will compensate for the feeding asymmetry imposed by the one or more crossings, and hence reduced coupling is achieved while the radiating pattern of the antenna remains symmetric.

In the following, four exemplary embodiments of the present invention will be presented.

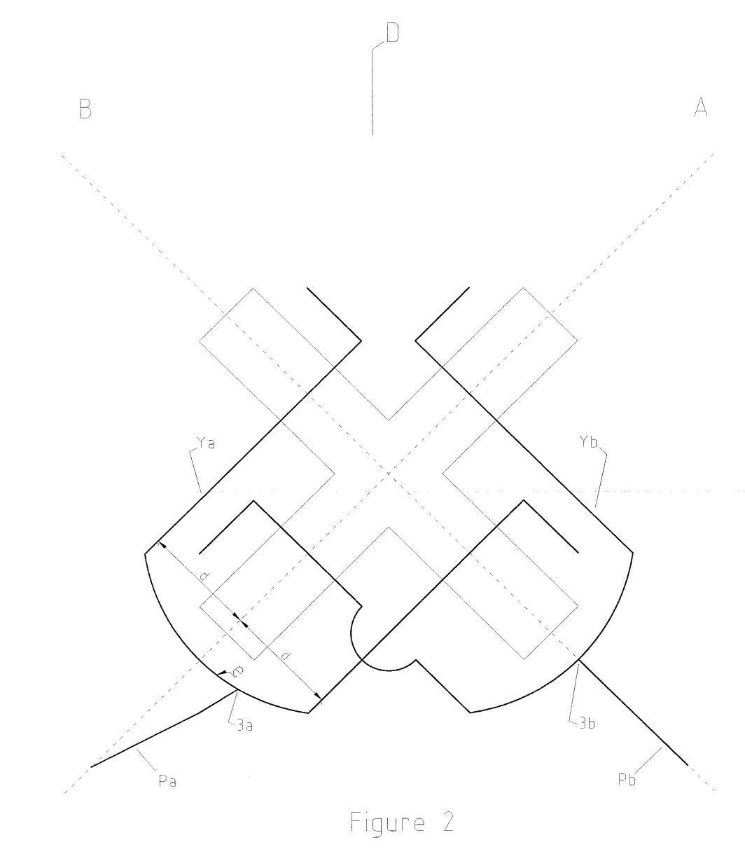

FIG. 2 shows a first embodiment of the present invention. In this figure two feeding junctions 3a and 3b are shown. In this particular example, the irregular configuration of the feeding arrangement involves the displacement of a first feeding junction 3a in relation to a symmetrical centre line A which passes centrally through a first pair of feed lines Ya. The purpose of the displacement is to compensate for the coupling introduced by the crossing 5. The feeding junction is displaced a distance e along one of the feed lines. The displacement of a distance e from the symmetrical line A will depend upon the degree of coupling introduced by the crossing. It should also be clear from this example that a second feeding junction 3b could be displaced relative to a centre line B instead of the feeding junction 3a relative to the line A, or both feeding junctions 3a and 3b could be displaced in relation to their respective centre lines A and B.

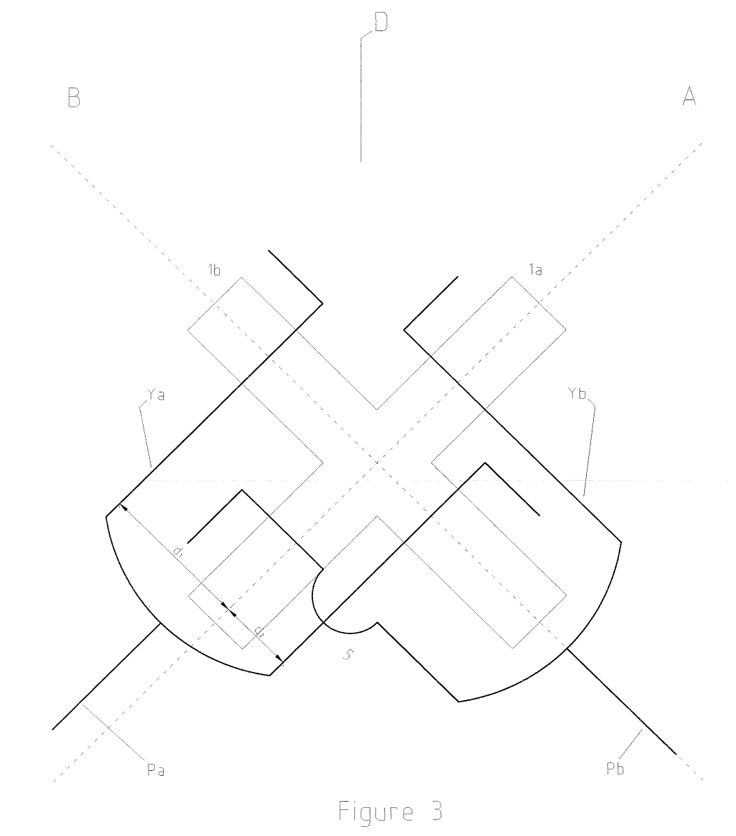

A second embodiment is shown in FIG. 3. In this embodiment the feeding arrangement is irregularly configured in that a first pair of feed lines Ya is displaced in relation to an associated aperture slot 1a which extends parallel thereto. The distance from the two feed lines to the centre of the aperture slot 1a is d₁ and d₂, respectively, where d₁≠d₂. The pair of feed lines Ya are displaced sideways in respect of the centre line of the aperture slot with an amount which compensates for the coupling imposed by the crossing 5. The pair of feed lines Ya could also be displaced sideways in the other direction in relation to the slot 1a. It is also clear from this example that a second pair of feed lines Yb could be displaced sideways in relation to an associated aperture slot 1b instead of the pair of feed lines Ya relative to the slot 1a, or both pair of feed lines Ya and Yb could be displaced in any direction in parallel to their associated slots 1a and 1b, respectively.

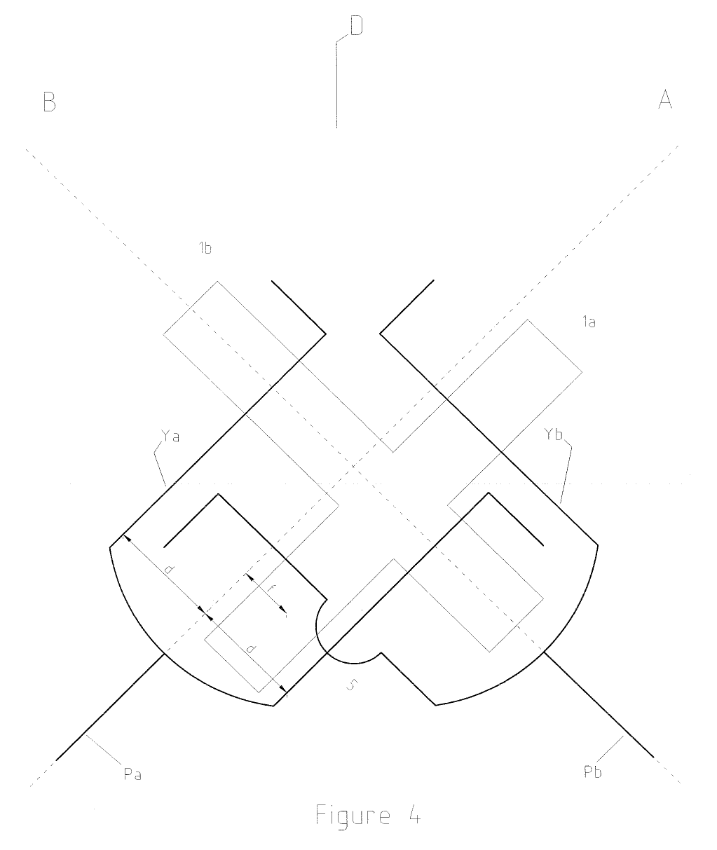

In FIG. 4 a third embodiment of the present invention is shown. The feeding arrangement in FIG. 4 is irregularly configured where a first aperture slot 1a is displaced sideways in relation to a second aperture slot 1b with a distance f from a symmetrical centre line A, but still remains perpendicular with the aperture slot 1b, while the pair of feed lines Ya and Yb are placed on their respective centre line A and B. Also, from this example it is clear that the aperture slot 1b could be displaced sideways in relation to the aperture slot 1a, or both aperture slots 1a and 1b could be displaced sideways in relation to each other while still remaining perpendicular to each other.

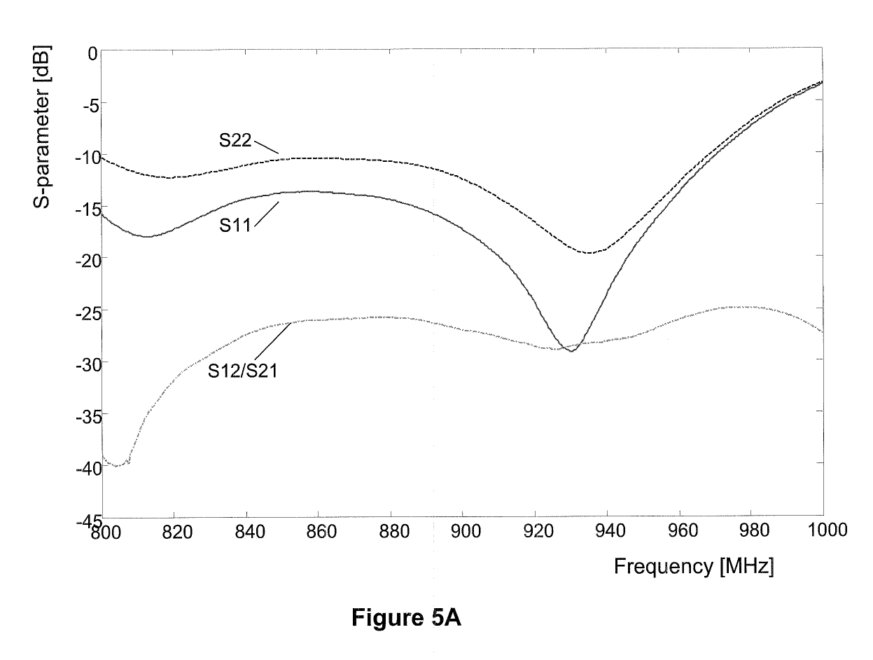

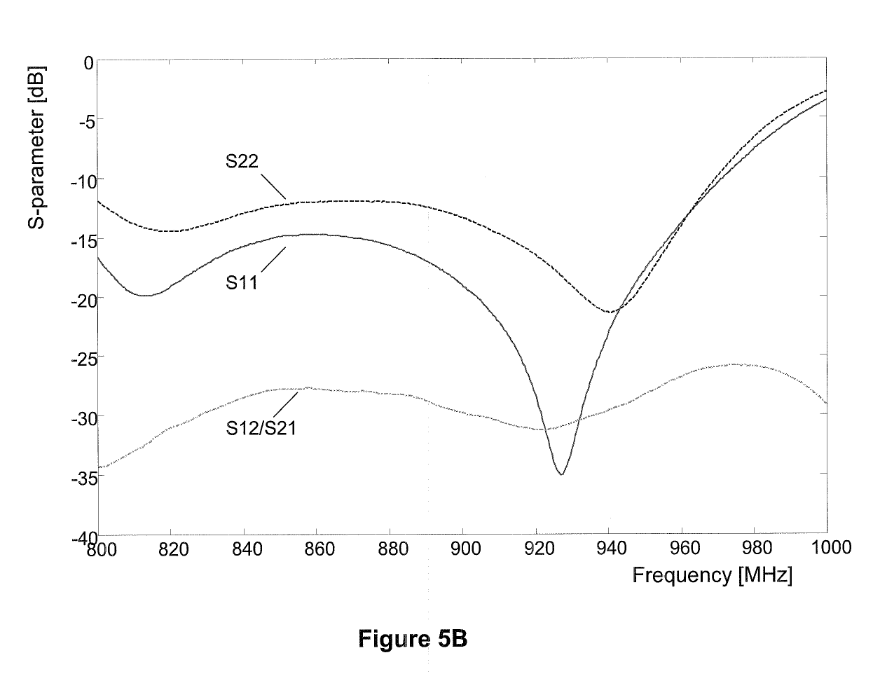

FIG. 5A shows a diagram of measured S-parameters for a feeding arrangement according to prior art, and FIG. 5B shows a diagram of measured S-parameters for a feeding arrangement according to the first embodiment of the present invention where feeding junctions are displaced. In this particular example, the feeding junctions 3a and 3b were each displaced by approximately 14 mm from the symmetrical lines A and B, respectively, i.e. e≈14 mm. From FIGS. 5A and 5B it can be concluded that the isolation with a feeding arrangement according to the present invention (FIG. 5B) is substantially improved over the relevant microwave range compared to the prior art solution (FIG. 5A).

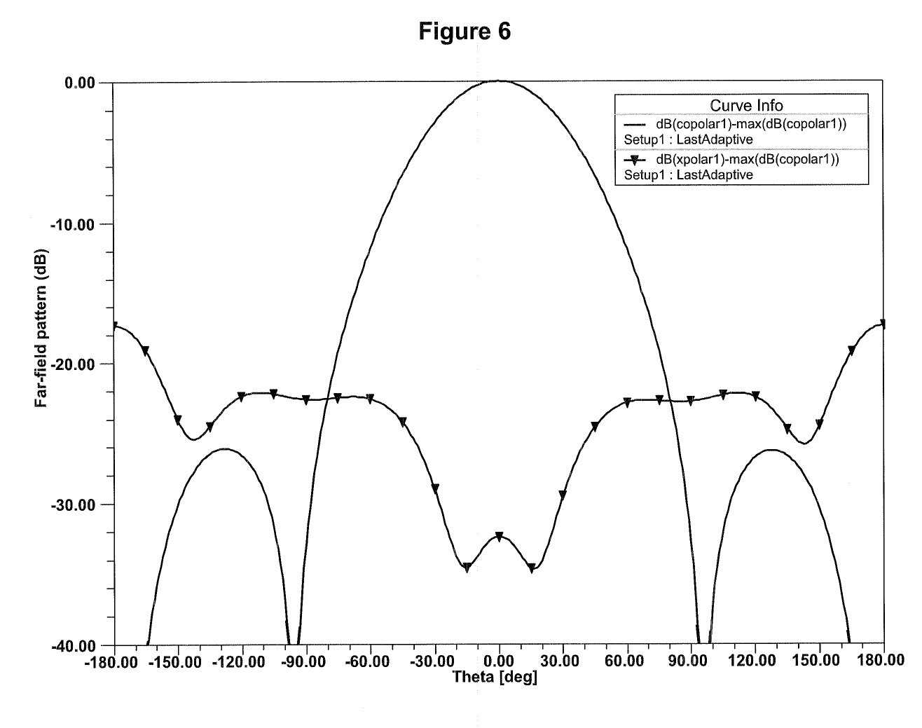

FIG. 6 shows simulation results of the radiation pattern of a patch antenna with a feeding arrangement according to one of the embodiments of the present invention. It can be seen from the diagram that the radiation pattern shows excellent radiation characteristics with minimum coupling in the desired main beam direction. Hence, FIG. 6 shows that the present invention has a good radiation directivity which is another important performance measure when designing dual polarized patch antennas of the present type.

It is obvious to the skilled person that the above embodiments may be combined such that a feeding arrangement according to the present invention may incorporate one, two, three or all four of the characteristics of the above embodiments. Therefore, the present invention offers the skilled person a high degree of freedom, in respect to design parameters, when designing a feeding arrangement which requires high isolation between the antenna ports in the presence of one or more crossings.

The skilled person also realizes that the present invention may be combined with other well known antenna isolation techniques in the art, e.g. the use of parasitic elements on the radiating side of the antenna and/or shield wall and/or non-quadratic patches etc. Hence, even more combinations are available to the skilled person in the design process.

The present invention is not limited by the described embodiments. The disclosed embodiments should merely be seen as possible alternatives of the inventive concept of the present invention which is only limited by the scope of the appended claims. Therefore, examples of modifications of the present invention, not disclosed in the application, could be: the shape of the aperture slots may have other geometrical shapes than those shown in the figures, but remain substantially rectangular; and the length of the different stubs may differ, and further the stubs may extend in both orthogonal directions from the top of the feed lines with different amounts.

1. A dual polarized aperture coupled patch antenna element, including at least one antenna patch and a feeding arrangement, wherein said feeding arrangement comprises:
a ground plane including: a first aperture slot and a second aperture slot, where said aperture slots cross each other perpendicularly;
a feeding plane including:
a first antenna port for feeding microwave energy via a first feeding junction into a first pair of feed lines which extend in parallel along said first aperture slot, on each side thereof;
a second antenna port for feeding microwave energy via a second feeding junction into a second pair of feed lines which extend in parallel along said second aperture slot, on each side thereof; and
where said feed lines cross each other in at least one point, at a mutual distance, wherein
at least a part of said feeding arrangement is irregularly configured for compensating for an imbalance caused by said crossing of said feed lines, whereby an increased isolation between said antenna ports is achieved.

2. A dual polarized aperture coupled patch antenna element according to claim 1, wherein at least one of said feeding junctions is displaced in relation to a centre line between the associated pair of feed lines.

3. A dual polarized aperture coupled patch antenna element according to claim 1 or 2, wherein at least one of said pair of feed lines is displaced sideways in relation to the associated aperture extending in parallel thereto.

4. A dual polarized aperture coupled patch antenna element according to anyone of claims 1, wherein at least one of said aperture slots is displaced sideways in relation to the other aperture slot.

5. A dual polarized aperture coupled patch antenna element according to claim 1, wherein said feed lines cross each other at a mutual distance at four points.

6. A dual polarized aperture coupled patch antenna element according to claim 1, wherein said aperture are substantially rectangular in shape.
